(19) United States
(12) Patent Application Publication
(10) Pub. No.: US 2009/0226290 A1
(43) Pub. Date: Sep. 10, 2009

(54) LIFTGATE FOR USE WITH DOCK LOCK MECHANISMS

(76) Inventor: Wayne Krause, Uniontown, OH (US)

Correspondence Address: Emerson, Thomson & Bennett, LLC, 777 W. Market Street, Akron, OH, 44303, US

(21) Appl. No.: 12/207,850

(22) Filed: Sep. 10, 2008

Related U.S. Application Data
(60) Provisional application No. 60/971,413, filed on Sep. 11, 2007.

(51) Int. Cl. B65G 69/34

(52) U.S. Cl. 414/399; 414/809

(57) ABSTRACT

A liftgate assembly may provide a dock lock engagement member at the appropriate height and distance for easy and secure engagement to a dock lock mechanism and may also beneficially include an adjustment mechanism allowing normal operation of the liftgate assembly even when encountering ground obstructions.

This application claims priority to U.S. Ser. No. 60/971,413, entitled LIFTGATE FOR USE WITH DOCK LOCK MECHANISMS, filed Sep. 11, 2007, which is incorporated herein by reference.

### I. BACKGROUND OF THE INVENTION

A. Field of Invention

This invention pertains to the art of methods and apparatuses regarding liftgates, and more specifically, to methods and apparatuses regarding the use of a liftgate with a dock lock mechanism and adjustment characteristics permitting normal operation even when encountering ground obstacles.

B. Description of the Related Art

It is well known in the art to attach liftgates to vehicle trailers or other forms of vehicle cargo holds to assist with loading and unloading of the vehicles. In general, liftgates include a platform or deck (platform assembly) and some motorized system, often including a hydraulic system, used to move the platform (lift assembly). To load cargo from a ground surface to the vehicle bed, the platform assembly is positioned in a lowered position where it is generally parallel with, and just above or on the same plane as, the ground surface. The cargo can then be easily placed onto the platform. The platform assembly is then lifted to a raised position generally parallel with the vehicle and generally on the same plane as the vehicle bed. The cargo can then be easily loaded into the vehicle. To unload cargo from the vehicle, the reverse steps are taken.

Various types and styles of liftgates are known in the art. Some liftgates, sometimes referred to as flip-a-way or fold-up liftgates, are foldable or collapsible into a stowed or storage condition. Often this storage condition is positioned underneath the vehicle cargo hold. When it is desirable to use the liftgate, it can be unfolded out of the storage condition.

A recent development in the field of loading docks is the use of a dock lock mechanism. Dock lock mechanisms generally are attached to the loading dock and have a hook member that swings outwardly from the loading dock to engage a portion of a truck or trailer (a dock lock engagement member) in order to hold or secure the truck or trailer to the loading dock. Dock lock mechanisms also generally have some type of indicating device, such as a colored light panel, that indicates to dock workers when the truck or trailer is in the proper secured-to-the-loading-dock position. In this way, dock workers receive a signal indicating that it is safe to begin loading and/or unloading operations with the truck or trailer. In order to be engaged to the dock lock mechanism, however, the dock lock engagement member must meet certain design criteria. The design criteria generally include: (1) a height requirement range (the dock lock engagement member must be within a specified height range from the ground surface); and, (2) a distance requirement range (the dock lock engagement member must be within a specified distance range from the back surface of the truck or trailer). For example, one type of dock lock mechanism requires that the dock lock engagement member have a height from the ground surface within the range of 20½ inches to 22½ inches and a distance from the back of the trailer within the range of 8½ inches to 9½ inches.

Because liftgate assemblies are often stowed or stored to the back, underneath portion of a truck or trailer, there is the possibility of interference with dock lock mechanisms. One solution to this interference problem is to provide the liftgate assembly with its own dock lock engagement member. In this way, the truck or trailer can be secured to the dock by engaging the dock lock mechanism directly to the liftgate assembly. This solution, however, may create additional problems. More specifically, the height and length range requirements of dock lock mechanisms may make normal operation of the liftgate (folding and unfolding of the liftgate, for example) more difficult. For example, designing a liftgate with a dock lock engagement member in the appropriate height and length range while the liftgate is in a stored position may cause the lift assembly to interfere with ground obstacles when lowering the platform into the lowered position. Interference with ground obstacles may prevent the platform from achieving the complete lowered position required for easy loading and unloading of cargo.

As a result, there is a need in the art for a liftgate assembly, with a dock lock engagement member residing at the correct height and distance in a stored position for engagement with a dock lock mechanism, that is also capable of the full range of normal operation even when presented with ground obstacles that might otherwise be an impediment. This invention provides methods and apparatuses regarding a liftgate assembly that can easily engage with a dock lock mechanism without the problems described above. This invention thus overcomes the foregoing difficulties and others while providing better and more advantageous overall results.

### II. SUMMARY OF THE INVENTION

According to one embodiment of this invention, a liftgate assembly for use with: (1) an associated loading dock having a dock surface and a dock lock mechanism; and, (2) an associated vehicle having a cargo hold with a vehicle bed, may comprise: (A) a mount assembly for use in mounting the liftgate assembly to the associated vehicle; (B) a platform assembly supported to the mount assembly and comprising a platform having a traffic surface for use in receiving traffic for loading and unloading associated cargo; (C) a lift assembly supported to the mount assembly for use in moving the platform between: (1) a storage position at least partially under the associated vehicle; (2) a lowered position juxtaposed to an associated ground surface; and, (3) a raised position juxtaposed to the vehicle bed; (D) a dock lock engagement mechanism supported to the mount assembly and comprising a dock lock engagement member that is operatively engagable to the associated dock lock mechanism to secure the associated vehicle to the loading dock; and, (E) an adjustment mechanism that: (1) when the dock lock engagement member contacts an obstruction on the associated ground surface as the platform is moved toward the lowered position, places the dock lock engagement member in a first position with respect to the platform when the platform is placed into the lowered position; and, (2) when the dock lock engagement member does not contact an obstruction on the associated ground surface as the platform is moved toward the lowered position, places the dock lock engagement member in a second position, that is substantially different than the first position, with respect to the platform when the platform is placed into the lowered position.

According to another embodiment of this invention, a liftgate assembly for use with: (1) an associated loading dock having a dock surface and a dock lock mechanism; and, (2) an associated vehicle having a cargo hold with a vehicle bed, may comprise: (A) a mount assembly for use in mounting the liftgate assembly to the associated vehicle; (B) a platform assembly supported to the mount assembly and comprising a platform having a traffic surface for use in receiving traffic for loading and unloading associated cargo; (C) a lift assembly supported to the mount assembly for use in moving the platform between: (1) a storage position at least partially under the associated vehicle; (2) a lowered position juxtaposed to an associated ground surface; and, (3) a raised position juxtaposed to the vehicle bed; (D) a dock lock engagement mechanism supported to the mount assembly and comprising a dock lock engagement member that is operatively engagable to the associated dock lock mechanism to secure the associated vehicle to the loading dock; and, (E) wherein the lift assembly moves the platform into the lowered position both: (1) when the dock lock engagement member does not contact an obstruction as the platform is placed into the lowered position; and, (2) when the dock lock engagement member contacts an obstruction on the associated ground surface as the platform is placed into the lowered position.

According to still another embodiment of this invention, a method may comprise the steps of: (A) providing a vehicle having a cargo hold with a vehicle bed; (B) providing the vehicle with a liftgate assembly for use with an associated loading dock having a dock surface and a dock lock mechanism; (C) providing the liftgate assembly with: (1) a mount assembly for use in mounting the liftgate assembly to the vehicle; (2) a platform assembly supported to the mount assembly and comprising a platform having a traffic surface for use in receiving traffic for loading and unloading associated cargo; (3) a lift assembly supported to the mount assembly for use in moving the platform between: (a) a storage position at least partially under the associated vehicle; (b) a lowered position juxtaposed to an associated ground surface; and, (c) a raised position juxtaposed to the vehicle bed; and, (4) a dock lock engagement mechanism supported to the mount assembly and comprising a dock lock engagement member that is operatively engagable to the associated dock lock mechanism to secure the associated vehicle to the loading dock; (D) moving the platform toward the lowered position; (E) contacting an obstruction on the associated ground surface with the dock lock engagement member; and, (F) discontinuing downward motion of the dock lock engagement member while moving the platform into the lowered position.

One advantage of this invention is that it provides a liftgate assembly with an integrated dock lock engagement member situated at the appropriate height and distance for easy operative engagement with an associated dock lock mechanism.

Another advantage of this invention is that it incorporates an adjustment mechanism that permits the liftgate assembly to engage in normal operation—including fully lowering the platform onto the ground surface—even when the dock lock engagement mechanism encounters ground obstructions.

Still other benefits and advantages of the invention will become apparent to those skilled in the art to which it pertains upon a reading and understanding of the following detailed specification.

### III. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a partial side view of a liftgate assembly in the storage position and attached to a vehicle that is near a loading dock.

FIG. 2 is a perspective bottom view of the liftgate assembly of this invention.

FIG. 3 is a partial side view of the liftgate assembly shown in FIG. 1.

FIG. 4 is a perspective top of view of the liftgate assembly of this invention; shown with the platform in a lowered position.

FIG. 5 is a partial cut-a-way side view of the liftgate assembly of this invention; with the platform shown in a lowered position on an even surface.

FIG. 6 is a partial cut-a-way side view of the liftgate assembly of this invention; with the platform shown in a lowered position on an uneven surface.

### III. DETAILED DESCRIPTION OF THE INVENTION

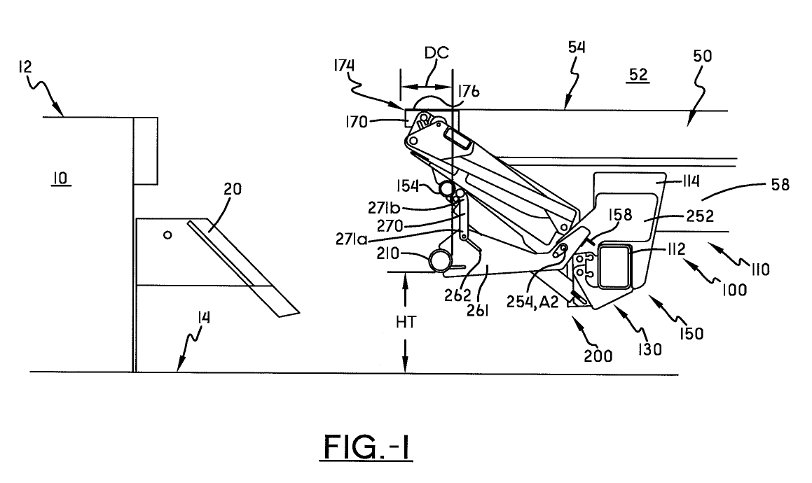

Referring now to the drawings wherein the showings are for purposes of illustrating embodiments of the invention only, and not for purposes of limiting the same, FIG. 1 shows a loading dock 10 equipped with a dock lock mechanism 20 which can be of any known design. As shown, the loading dock 10 has a dock surface 12 that extends above a ground surface 14 upon which a vehicle 50 such as a truck or trailer is supported as it is positioned near the loading dock 10. As the operation and use of a dock 10 is well known, further details will not be provided here.

With continuing reference to FIG. 1, the vehicle 50 may include a cargo hold 52 having a vehicle bed 54. The vehicle 50 may also have a sill at the outer edge of the cargo hold 52 and conventional vehicle frame members 58. Any type and style of vehicle will work well with this invention when applied with the sound judgment of a person of skill in the art. The vehicle 50 may be positioned relatively close to the outer edge of the loading dock 10 so that the dock surface 12 and the vehicle bed 54 are substantially parallel and substantially on the same plane. This is the well known appropriate position for loading and/or unloading cargo into the vehicle 50. FIG. 1 also indicates the appropriate height HT and distance DC, according to one non-limiting embodiment of this invention, at which a dock lock engagement member 210 must reside when the liftgate assembly is in a stored position, so that it properly engages with the dock lock mechanism 20.

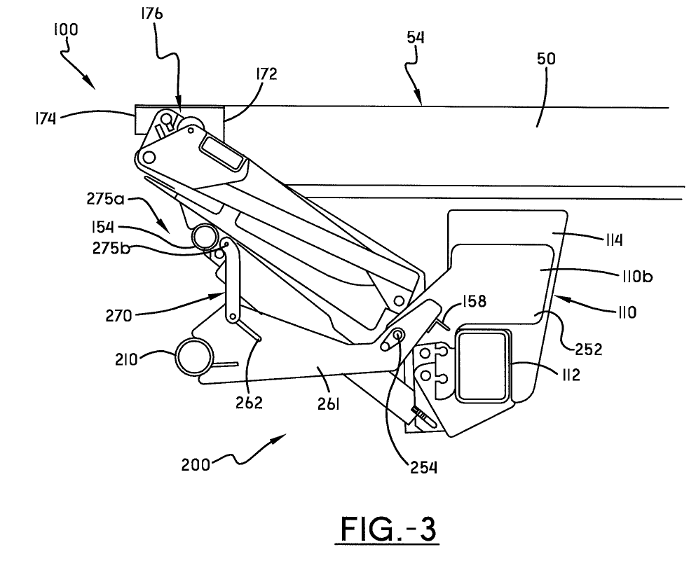

With reference now to FIGS. 1-4, a liftgate assembly 100, including a dock lock engagement mechanism 200 according to one embodiment of this invention, may be mounted to the vehicle's mount assembly 110, such as to the vehicle frame members 58, in any conventional manner. While the liftgate assembly 100 shown is the style known as flip-a-way or fold-up, it is to be noted that this invention may be used with any liftgate style, type and size, when applied with the sound judgment of a person of skill in the art. The liftgate assembly 100 may include a mount assembly 110 (having first and second sides 110a, 110b), a platform assembly 130 including a platform or deck 132, a lift assembly 150 (having first and second sides 150a, 150b), a bed extension 170, and the previously noted dock lock engagement mechanism 200. The mount assembly 110 may include one or more mounting tubes 112, one or more mounting plates 114, and one or more plates 252, as well as other components shown but not referenced. The mount assembly 110 is used to mount the liftgate assembly 100 to the vehicle frame in any conventional manner and thus will not be described in detail. The platform 132 may have a traffic surface 134 that may be used to receive traffic for loading and unloading cargo as is well known. The bed extension 170 may have a first side 172 that abuts the vehicle 50, such as along the sill, as shown, and a second side 174 that may abut a first end of the platform 132 when the platform 132 is in a raised position (not shown). The second side 174 of the bed extension 170 may be positioned near the outer edge of the dock 10 for loading and unloading purposes. The bed extension 170 may also have a traffic surface 176 that may be used to receive traffic for loading and unloading cargo. It should be noted that a bed extension 170 is not required for this invention because in an alternate embodiment, not shown, the platform 132 may have a first side 133 that abuts the vehicle 50, such as along the sill, making the use of a bed extension 170 unnecessary.

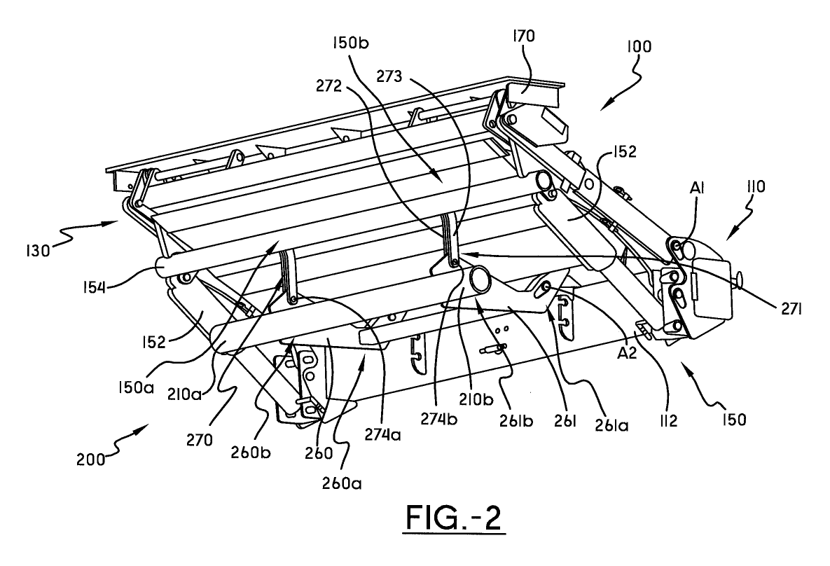

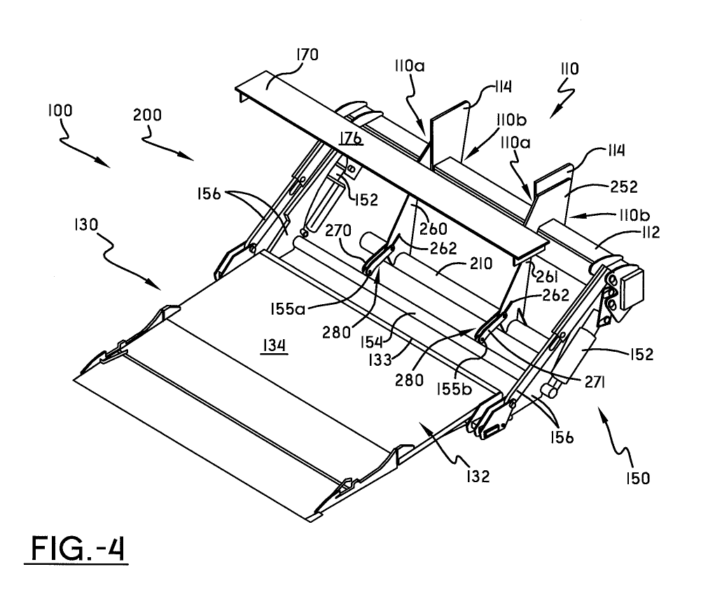

With continuing reference to FIGS. 1-4, the lift assembly 150 may be used to move the platform 132 between a folded storage position (shown in FIGS. 1, 2, and 3), a lowered position (shown in FIG. 4) and a raised position (not shown but, as is well known, where the traffic surface 134 of the platform or deck 132 is substantially parallel with the traffic surface 176 of the bed extension 170 and substantially on the same plane as the vehicle bed 54). The lift assembly 150 may include a control system (not shown) and a hydraulic system (not shown) used to operate one or more cylinders 152 (referenced in FIGS. 2 and 4) to move the platform 132. The control and hydraulic systems raise and lower the platform assembly 130 by raising and lowering lift arms 156, and the lift tube 154 extending between and connected to the lift arms 156. The basic operation of the control and hydraulic systems are well known and will not be described in detail.

Still referring to FIGS. 1-4, the dock lock engagement mechanism 200 is used to engage with the dock lock mechanism 20. The dock lock engagement mechanism 200 may include a dock lock engagement member 210 (having first and second sides 210a, 210b) that engages the hook of the dock lock mechanism 20 in a known manner. The dock lock engagement member 210 may be of any size and shape chosen with the sound judgment of a person of skill in the art. For the embodiment shown, the dock lock engagement member 210 is a tube with a circular cross-section. The dock lock engagement member 210 of this invention advantageously also serves as a bumper for the vehicle 50, although that is not necessary for this invention. The dock lock engagement mechanism 200 also may include a first brace 260 for use in attaching the dock lock engagement member 210 to the mount assembly 110. The first brace 260 also works with the lift assembly 150 to properly position the dock lock engagement member 210 as the platform 132 is raised, lowered, and folded into the storage position.

With continuing reference to FIGS. 1-4, the first brace 260 has a first end 260a that pivotally connects the first brace 260 to the first side of the mount assembly 110a, and a second end 260b that operatively attaches the first brace 260 to the first side of the dock lock engagement member 210a. In the embodiment shown in FIG. 4, a second brace 261 is shown; the second brace 261 also has a first end 261a that pivotally connects the second brace to the second side of the mount assembly 110b, and a second end 261b that operatively attaches the second brace 261 to the second side of the dock lock engagement member 210b. Each brace 260, 261 may be attached at its second end 260b, 261b, such as by welding, to the dock lock engagement member 210. Each brace 260, 261 may be attached at its first end 260a, 261a with a pivotal connection to the mount assembly 110. For the embodiment shown, the mount assembly 110 comprises at least a plate 252 that may be fixedly attached to a mount plate 114 such as by welding. The plate 252 may have a hole that receives a pivot pin 254 which is also received in a hole formed in the brace 260, 261. This attachment allows the brace 260 to pivot about pivot axis A2 with respect to the plate 252 about the pivot pin 254. In one embodiment, the pivot pin 254 is not in line with the pivot axis A1 of the lift arms 156 which are well-known components used to lift and lower liftgate platform assemblies 130. As a result, this pivotal connection provides an independent pivot point for the brace 260 that permits pivoting motion independent of the lift arms 156 (that is, a different rotation arc). This independent pivot point allows the lift assembly's 150 lift arms 156 to continue to lower the platform assembly 130 to a position substantially in contact with the ground surface 14, even after movement of the dock lock engagement mechanism 200 has been halted (by a ground obstruction, for example). A stop member 158 may also be attached to the plate 252 and used to stop or limit the upward rotation of the brace 260.

Still referring to FIGS. 1-4, the independent movement of the lift assembly 150 and dock lock engagement mechanism 200 is possible because of this invention's adjustment mechanism 280. The adjustment mechanism 280 comprises at least a first link 270, having a first end 270a that may be pivotally attached to the first brace 260, and a second end 270b that may be attached to the first side of the lift assembly 150a. In another embodiment of this invention, the adjustment mechanism 280 also comprises a second link 271, having a first end 271a that may be pivotally attached to the second brace 261, and a second end 271b that may be attached to the second side of the lift assembly 150b. In the embodiment shown in FIGS. 2 and 4, each link 270, 271 includes first and second plates 272, 273, whereby first pins 274a, 274b pass through holes in the first ends 270a, 271a and second pins 275a, 275b pass through holes in the second ends 270b, 271b; the first and second pins 274, 275 being substantially positioned between the plates 272, 273. In the embodiment shown in FIG. 4, the links' 270, 271 first pins 274a, 274b are pivotal and slidable within a groove 262 formed in the braces 260, 261, while the links' 270, 271 second pins 275a, 275b are pivotally attached within an opening formed on the lift assembly 150. For the embodiment shown in FIG. 4, the links 270, 271 pivot about second pins 275a, 275b passing through its plates 272, 273 and openings in an ear 155a, 155b formed on the lift assembly's 150 lift tube 154. This attachment configuration allows the links 270, 271 to pivot with respect to the lift tube 154, and to pivot or slide with respect to the grooves 262 formed in the braces 260, 261.

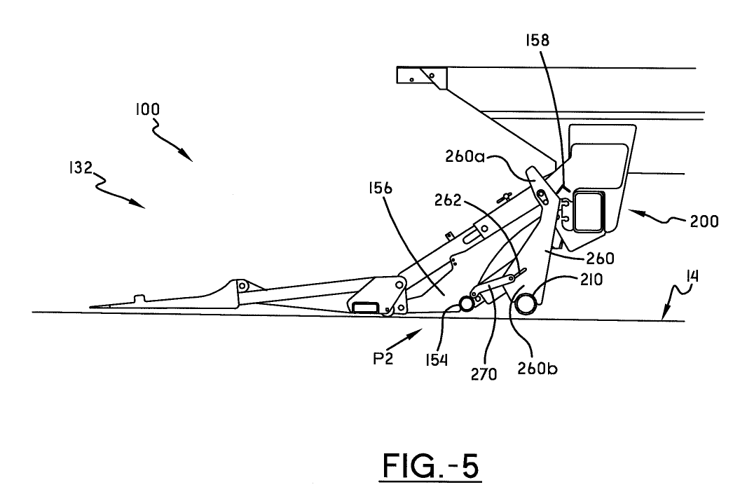

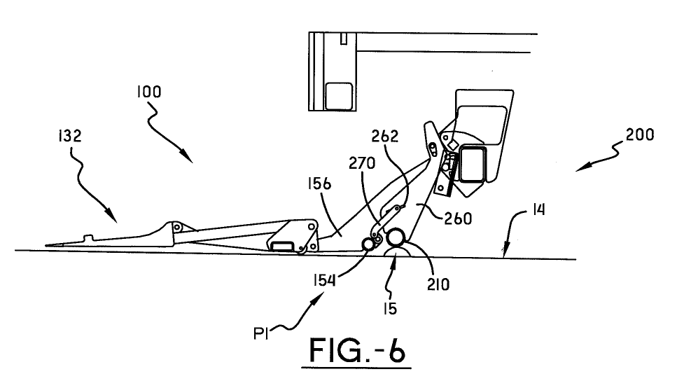

The liftgate assembly of this invention utilizes the cooperative movements of the lift assembly 150, adjustment mechanism 180, and dock lock engagement mechanism 200 to adapt to disparate operational conditions. For example, this invention moves the lift assembly 150 and attached platform assembly 130 into a fully lowered position irrespective of ground conditions. As shown in FIG. 5, when the dock lock engagement member 210 does not encounter a ground obstruction 15, the liftgate assembly 100 operates in a normal fashion whereby the platform 130 is fully lowered into a second position P2. As shown in FIG. 6, however, when the dock lock engagement member 210 does encounter a ground obstruction 15, the platform assembly 130 is still capable of being fully lowered onto the ground surface 14 by virtue of adjustment mechanism 280 movement; but the dock lock engagement member 210 now resides in a first position P1 that is substantially different than the position of the dock lock engagement member 210 in the second position P2. Adjustment mechanism 280 movement is appropriately characterized as follows: A) when the liftgate assembly 100 is being moved towards a lowered position, and the dock lock engagement member 210 encounters a ground obstruction 15 that prematurely halts the downward movement of the dock lock engagement mechanism 200, B) the links 270, 271 and first pins 274a, 274b pivot and/or slide within the braces' grooves 262, C) while the links 270, 271 and second pins 275a, 275b also pivot with respect to the attached lift tube 154 in order to accommodate the continued downward movement of the lift assembly 150.

The advantages of this invention can be appreciated by comparing FIG. 5 to FIG. 6. Both of these figures show the liftgate assembly 100 in the lowered position. FIG. 6, however, shows an obstruction 15 extending above the ground surface 14. This obstruction 15 may be a rock, a piece of asphalt or concrete, or any other cause of an uneven ground surface. When the liftgate assembly 100 is used on an even surface, as shown in FIG. 5, its operation goes smoothly. When the liftgate assembly 100 is used on an uneven surface, as shown in FIG. 6, its operation still goes smoothly because of this invention. More specifically, as the liftgate assembly 100 is pivoted downward the dock lock engagement member 210 may contact the obstruction 15. This does not prevent the continued rotation downward of the platform 132, however, because each link 270, 271 simply slides within the corresponding groove 262, and/or pivots with respect to the lift tube 154.

Multiple embodiments have been described, hereinabove. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Having thus described the invention, it is now claimed:

I/we claim:

1. A liftgate assembly for use with: (1) an associated loading dock having a dock surface and a dock lock mechanism; and, (2) an associated vehicle having a cargo hold with a vehicle bed, the liftgate assembly comprising:
a mount assembly for use in mounting the liftgate assembly to the associated vehicle;
a platform assembly supported to the mount assembly and comprising a platform having a traffic surface for use in receiving traffic for loading and unloading associated cargo;
a lift assembly supported to the mount assembly for use in moving the platform between: (1) a storage position at least partially under the associated vehicle; (2) a lowered position juxtaposed to an associated ground surface; and, (3) a raised position juxtaposed to the vehicle bed;
a dock lock engagement mechanism supported to the mount assembly and comprising a dock lock engagement member that is operatively engagable to the associated dock lock mechanism to secure the associated vehicle to the loading dock; and,
an adjustment mechanism that: (1) when the dock lock engagement member contacts an obstruction on the associated ground surface as the platform is moved toward the lowered position, places the dock lock engagement member in a first position with respect to the platform when the platform is placed into the lowered position; and, (2) when the dock lock engagement member does not contact an obstruction on the associated ground surface as the platform is moved toward the lowered position, places the dock lock engagement member in a second position, that is substantially different than the first position, with respect to the platform when the platform is placed into the lowered position.

2. The liftgate assembly of claim 1 wherein:
the dock lock engagement mechanism comprises: a first brace having a first end that is pivotally connected to the mount assembly and a second end that is operatively attached to the dock lock engagement member; and,
the adjustment mechanism comprises: a first link having a first end that is pivotally connected to the first brace and a second end that is pivotally connected to the lift assembly.

3. The liftgate assembly of claim 2 wherein the first link comprises:
a first pin that is positioned on the first end of the link and that is pivotal and slidable within a groove formed on the first brace; and,
a second pin that is positioned on the second end of the link and that is pivotal within an opening formed on the lift assembly.

4. The liftgate assembly of claim 3 wherein:
the first link further comprises: first and second plates; and,
the first and second pins are each positioned substantially between the first and second plates.

5. The liftgate assembly of claim 3 wherein the lift assembly comprises:
a lift tube having a first ear that extends from the lift tube and that has an opening that receives the second pin.

6. The liftgate assembly of claim 2 wherein:
the mount assembly has first and second sides;
the lift assembly has first and second sides;
the dock lock engagement member has first and second sides;
the first end of the first brace is pivotally connected to the first side of the mount assembly;
the second end of the first brace is fixedly attached to the first side of the dock lock engagement member;
the first end of the first link is pivotally connected to the first brace;
the second end of the first link is pivotally connected to the first side of the lift assembly;
the dock lock engagement mechanism further comprises: a second brace having: (1) a first end that is pivotally connected to the second side of the mount assembly; and, (2) a second end that is fixedly attached to the second side of the dock lock engagement member; and,
the adjustment mechanism further comprises: a second link having: (1) a first end that is pivotally connected to the second brace; and, (2) a second end that is pivotally connected to the second side of the lift assembly.

7. The liftgate assembly of claim 1 wherein:
the dock lock engagement mechanism comprises: a first brace having a first end that is pivotally connected to the mount assembly and a second end that is operatively attached to the dock lock engagement member; and,
the adjustment mechanism comprises: a first link having a first end that is slideable within a groove formed on the brace and a second end that is pivotally connected to the lift assembly.

8. The liftgate assembly of claim 1 further comprising:
a bed extension having: (1) a first side that abuts a rear end of the associated vehicle; and, (2) a second side that abuts the platform when the platform is in the raised position.

9. A liftgate assembly for use with: (1) an associated loading dock having a dock surface and a dock lock mechanism; and, (2) an associated vehicle having a cargo hold with a vehicle bed, the liftgate assembly comprising:
a mount assembly for use in mounting the liftgate assembly to the associated vehicle;
a platform assembly supported to the mount assembly and comprising a platform having a traffic surface for use in receiving traffic for loading and unloading associated cargo;
a lift assembly supported to the mount assembly for use in moving the platform between: (1) a storage position at least partially under the associated vehicle; (2) a lowered position juxtaposed to an associated ground surface; and, (3) a raised position juxtaposed to the vehicle bed;
a dock lock engagement mechanism supported to the mount assembly and comprising a dock lock engagement member that is operatively engagable to the associated dock lock mechanism to secure the associated vehicle to the loading dock; and,
wherein the lift assembly moves the platform into the lowered position both: (1) when the dock lock engagement member does not contact an obstruction as the platform is placed into the lowered position; and, (2) when the dock lock engagement member contacts an obstruction on the associated ground surface as the platform is placed into the lowered position.

10. The liftgate assembly of claim 9 further comprising:
an adjustment mechanism that: (1) when the dock lock engagement member contacts an obstruction on the associated ground surface as the platform is moved toward the lowered position, places the dock lock engagement member in a first position with respect to the platform when the platform is placed into the lowered position; and, (2) when the dock lock engagement member does not contact an obstruction on the associated ground surface as the platform is moved toward the lowered position, places the dock lock engagement member in a second position, that is substantially different than the first position, with respect to the platform when the platform is placed into the lowered position.

11. The liftgate assembly of claim 10 wherein:
the dock lock engagement mechanism comprises: a first brace having a first end that is pivotally connected to the mount assembly and a second end that is operatively attached to the dock lock engagement member; and,
the adjustment mechanism comprises: a first link having a first end that is pivotally connected to the first brace and a second end that is pivotally connected to the lift assembly.

12. The liftgate assembly of claim 11 wherein the first link comprises:
a first pin that is positioned on the first end of the link and that is pivotal and slidable within a groove formed on the first brace; and,
a second pin that is positioned on the second end of the link and that is pivotal within an opening formed on the lift assembly.

13. The liftgate assembly of claim 12 wherein:
the first link further comprises: first and second plates; and,
the first and second pins are each positioned substantially between the first and second plates.

14. The liftgate assembly of claim 12 wherein the lift assembly comprises:
a lift tube having a first ear that extends from the lift tube and that has an opening that receives the second pin.

15. The liftgate assembly of claim 11 wherein:
the mount assembly has first and second ends;
the lift assembly has first and second ends;
the dock lock engagement member has first and second ends;
the first end of the first brace is pivotally connected to the first end of the mount assembly;
the second end of the first brace is fixedly attached to the first end of the dock lock engagement member;
the first end of the first link is pivotally connected to the first brace;
the second end of the first link is pivotally connected to the first end of the lift assembly;
the dock lock engagement mechanism further comprises: a second brace having: (1) a first end that is pivotally connected to the second end of the mount assembly; and, (2) a second end that is fixedly attached to the second end of the dock lock engagement member; and,
the adjustment mechanism further comprises: a second link having: (1) a first end that is pivotally connected to the second brace; and, (2) a second end that is pivotally connected to the second end of the lift assembly.

16. The liftgate assembly of claim 10 wherein:
the dock lock engagement mechanism comprises: a first brace having a first end that is pivotally connected to the mount assembly and a second end that is operatively attached to the dock lock engagement member; and,
the adjustment mechanism comprises: a first link having a first end that is slideable within a groove formed on the brace and a second end that is pivotally connected to the lift assembly.

17. The liftgate assembly of claim 10 further comprising:
a bed extension having: (1) a first side that abuts a rear end of the associated vehicle; and,
(2) a second side that abuts the platform when the platform is in the raised position.

18. A method comprising the steps of:
(A) providing a vehicle having a cargo hold with a vehicle bed;
(B) providing the vehicle with a liftgate assembly for use with an associated loading dock having a dock surface and a dock lock mechanism;
(C) providing the liftgate assembly with: (1) a mount assembly for use in mounting the liftgate assembly to the vehicle; (2) a platform assembly supported to the mount assembly and comprising a platform having a traffic surface for use in receiving traffic for loading and unloading associated cargo; (3) a lift assembly supported to the mount assembly for use in moving the platform between: (a) a storage position at least partially under the associated vehicle; (b) a lowered position juxtaposed to an associated ground surface; and, (c) a raised position juxtaposed to the vehicle bed; and, (4) a dock lock engagement mechanism supported to the mount assembly and comprising a dock lock engagement member that is operatively engagable to the associated dock lock mechanism to secure the associated vehicle to the loading dock;
(D) moving the platform toward the lowered position;
(E) contacting an obstruction on the associated ground surface with the dock lock engagement member; and,
(F) discontinuing downward motion of the dock lock engagement member while moving the platform into the lowered position.
